(19) United States
(12) Patent Application Publication
(10) Pub. No.: US 2019/0059628 A1
(43) Pub. Date: Feb. 28, 2019

(54) CONTROL METHOD FOR RICE COOKER AND RICE COOKER

(71) Applicant: FOSHAN SHUNDE MIDEA ELECTRICAL HEATING APPLIANCES MANUFACTURING CO., LIMITED, Foshan (CN)

(72) Inventors: Huayong LIU, Foshan (CN); Feilong LUO, Foshan (CN); Weiming HUANG, Foshan (CN); Zhijia LIANG, Foshan (CN); Li MA, Foshan (CN); Xiaoliang YANG, Foshan (CN)

(21) Appl. No.: 16/030,876

(22) Filed: Jul. 10, 2018

Related U.S. Application Data
(63) Continuation of application No. PCT/CN2017/099400, filed on Aug. 29, 2017.

(30) Foreign Application Priority Data
May 27, 2018 (CN) 201710393012.9
May 27, 2018 (CN) 201720617461.2

(51) Int. Cl. A47J 27/08; A47J 27/09; A23L 5/10; A23L 7/10

(52) U.S. Cl. CPC A47J 27/0802; A47J 27/09; A23V 2002/00; A23L 7/1975; A23L 5/13

(57) ABSTRACT

A control method for a rice cooker and the rice cooker are provided. The control method includes controlling a pressure-changing device to change a pressure in a cooking cavity of the rice cooker from a normal pressure to a first pressure, when the rice cooker enters a water absorption stage, and controlling the pressure-changing device to enable the pressure in the cooking cavity to alternate between a second pressure and a third pressure, after the pressure in the cooking cavity is changed to the first pressure.

### CROSS-REFERENCE TO RELATED APPLICATION

This application is a national phase entry under 35 USC § 371 of International Application PCT/CN2016/080699, filed Apr. 29, 2016, which claims priority to and benefits of Chinese Patent Applications Serial No. 201610255435.X, filed with the State Intellectual Property Office of P. R. China on Apr. 20, 2016, the entire contents of which are incorporated herein by reference.

### FIELD

The present disclosure relates to a technical field of electrical appliance manufacture, more particularly, to a control method for a rice cooker, a rice cooker that performs cooking through the control method and a rice cooker.

### BACKGROUND

The water absorption speed of rice grains and the water content after the water absorption are key factors influencing the quality of cooked rice.

A rice cooker in the related art relies on water itself permeating into rice grains, which causes slow water absorption and low water content, thereby influencing the quality of cooked rice and cooking time.

### SUMMARY

Embodiments of the present disclosure seek to solve at least one of the problems existing in the related art. To this end, the present disclosure proposes a control method for a rice cooker, and the control method for the rice cooker has advantages of a good cooking effect and high cooking efficiency.

The present disclosure further proposes a rice cooker that performs cooking through the control method for the rice cooker.

The present disclosure further proposes a rice cooker.

To achieve the above purposes, embodiments of a first aspect of the present disclosure propose a control method for a rice cooker. A cooking stage of the rice cooker at least includes a water absorption stage, a heating stage and a boiling stage. The rice cooker includes a pot, a cover and a pressure-changing device, the pot defines a cooking cavity therein, the cover is mounted to the pot and movable between a closed position and an open position, and the pressure-changing device is disposed to the pot and/or the cover to control a pressure in the cooking cavity to change. The control method includes:

When the rice cooker enters the water absorption stage, controlling the pressure-changing device to change the pressure in the cooking cavity of the rice cooker from a normal pressure to a first pressure;

After the pressure in the cooking cavity is changed to the first pressure, controlling the pressure-changing device to enable the pressure in the cooking cavity to alternate between a second pressure and a third pressure.

The control method according to embodiments of the present disclosure has advantages of the good cooking effect and the high cooking efficiency.

Additionally, the control method according to embodiments of the present disclosure may further have the following additional technical features.

According to one embodiment of the present disclosure, the second pressure and the third pressure are both positive pressures or are both negative pressures; or one of the second pressure and the third pressure is the positive pressure, and the other of the second pressure and the third pressure is the negative pressure, in which an absolute value of a difference between the second pressure and the third pressure is ΔP, and the ΔP≥1 KPa.

According to one embodiment of the present disclosure, one of the second pressure and the third pressure is equal to the first pressure, and the other of the second pressure and the third pressure is greater than or smaller than the first pressure.

According to one embodiment of the present disclosure, one of the second pressure and the third pressure is greater than the first pressure, and the other of the second pressure and the third pressure is smaller than the first pressure.

According to one embodiment of the present disclosure, the second pressure and the third pressure are both greater than or are both smaller than the first pressure.

According to one embodiment of the present disclosure, the control method further includes:

S3: when the pressure in the cooking cavity alternates between the second pressure and the third pressure for a predetermined water absorption time, controlling the rice cooker to enter the heating stage.

According to one embodiment of the present disclosure, the control method further includes detecting the pressure in the cooking cavity in real time, and controlling the pressure-changing device depending on the pressure in the cooking cavity.

Embodiments of a second aspect of the present disclosure proposes a rice cooker, and the rice cooker performs cooking through the control method for the rice cooker according to embodiments of the first aspect of the present disclosure.

By performing cooking through the control method for the rice cooker according to embodiments of the first aspect of the present disclosure, the rice cooker according to embodiments of the present disclosure has advantages of the good cooking effect and the high cooking efficiency.

Embodiments of a third aspect of the present disclosure proposes a rice cooker. The rice cooker includes a pot defining a cooking cavity therein; a cover mounted to the pot and movable between a closed position and an open position; and a pressure-changing device disposed to the pot and/or the cover to change a pressure in the cooking cavity, in which the pressure-changing device is configured to change the pressure in the cooking cavity of the rice cooker from a normal pressure to a first pressure when the rice cooker enters a water absorption stage of a cooking stage, and is configured to enable the pressure in the cooking cavity to alternate between a second pressure and a third pressure after the pressure in the cooking cavity is changed to the first pressure.

The rice cooker according to embodiments of the present disclosure has advantages of the good cooking effect and the high cooking efficiency.

According to one embodiment of the present disclosure, the pressure-changing device includes a negative pressure device disposed in the pot or the cover to achieve a negative pressure in the cooking cavity; and a pressurizing device disposed in the pot or the cover to pressurize the cooking cavity.

According to one embodiment of the present disclosure, the rice cooker further includes a pressure detection device, in which the pressure detection device is disposed in the pot and detects the pressure in the cooking cavity in real time and controls the pressure-changing device depending on the pressure in the cooking cavity.

According to one embodiment of the present disclosure, the negative pressure device includes an airflow path having a first end in communication with the cooking cavity and a second end in communication with an air storage device or the outside; and a vacuum pump in communication with the airflow path to generate the negative pressure in the cooking cavity.

According to one embodiment of the present disclosure, the negative pressure device is disposed in the cover, an air extraction opening is defined in a surface of the cover fitted with the cooking cavity, and the air extraction opening is in communication with the airflow path.

According to one embodiment of the present disclosure, the negative pressure device further comprises an electromagnetic valve connected between the air extraction opening and the vacuum pump.

According to one embodiment of the present disclosure, the pressurizing device is disposed in the cover, and is in communication with the cooking cavity through an air intake port, the air intake port being defined in a surface of the cover fitted with the cooking cavity.

According to one embodiment of the present disclosure, the pressurizing device includes a blocking member disposed at the air intake port and movable between a blocked position and an unblocked position, in which the blocking member closes the air intake port when in the blocked position, and the cooking cavity is in communication with the outside when the blocking member is in the unblocked position.

According to one embodiment of the present disclosure, the pressurizing device further includes a drive assembly, and the drive assembly drives the blocking member to move between the blocked position and the unblocked position.

According to one embodiment of the present disclosure, the drive assembly includes an electromagnet and a push rod, and the electromagnet drives the push rod to urge the blocking member to move.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow diagram of a control method for a rice cooker according to an embodiment of the present disclosure.

FIG. 2 is a schematic view of a pressure change in a control method for a rice cooker according to an embodiment of the present disclosure.

FIG. 3 is a sectional view of a rice cooker according to an embodiment of the present disclosure.

Reference numerals: rice cooker 1; pot 10; inner pot 20; cooking cavity 21; cover 30; air extraction opening 31; negative pressure device 40; vacuum pump 41; airflow path 42; pressure detection device 50.

### DETAILED DESCRIPTION

Embodiments of the present disclosure will be described in detail and examples of the embodiments will be illustrated in the drawings, where same or similar reference numerals are used to indicate same or similar members or members with same or similar functions. The embodiments described herein with reference to drawings are explanatory, illustrative, and used to generally understand the present disclosure. The embodiments shall not be construed to limit the present disclosure.

In the specification, it is to be understood that terms such as “central,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial” and “circumferential” should be construed to refer to the orientation as then described or as shown in the drawings under discussion. These relative terms are for convenience of description and do not require that the present disclosure be constructed or operated in a particular orientation. In addition, the feature defined with “first” and “second” may comprise one or more of this feature. In the description of the present disclosure, “a plurality of” means two or more than two, unless specified otherwise.

In the present disclosure, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements.

A control method for a rice cooker according to embodiments of the present disclosure will be described with reference to drawings in the following.

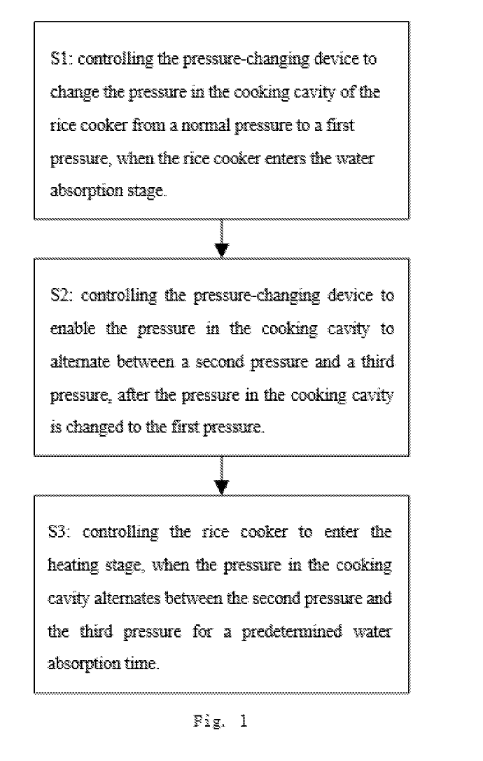

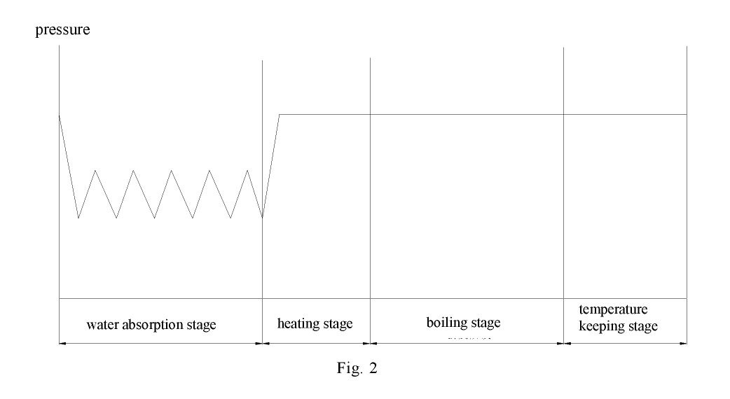

As illustrated in FIGS. 1 and 2, a cooking stage of the rice cooker at least includes a water absorption stage, a heating stage and a boiling stage. The rice cooker includes a pot, a cover and a pressure-changing device. The pot defines a cooking cavity therein; the cover is mounted to the pot and is movable between a closed position and an open position; the pressure-changing device is disposed to the pot and/or the cover to control a pressure in the cooking cavity to change. The control method according to embodiments of the present disclosure includes:

When the rice cooker enters the water absorption stage, controlling the pressure-changing device to change the pressure in the cooking cavity of the rice cooker from a normal pressure to a first pressure;

After the pressure in the cooking cavity is changed to the first pressure, controlling the pressure-changing device to enable the pressure in the cooking cavity to alternate between a second pressure and a third pressure.

In the control method according to embodiments of the present disclosure, by providing the water absorption stage, when water and rice are placed in the rice cooker, rice grains can absorb moisture, so as to improve quality of cooked rice and shorten a time required for cooking the rice.

Moreover, by changing the pressure in the cooking cavity from the normal pressure to the first pressure, the pressure in the cooking cavity can reach a pressure value which is most suitable for the water absorption of rice grains, and an environment in cooking cavity reaches an environment which is most suitable for the water absorption of rice grains, such that water absorption efficiency of rice grains can be improved, water content of rice grains can be ensured to guarantee the quality of the cooked rice, and also the time required for cooking the rice can be shortened to improve cooking efficiency of the rice cooker.

In addition, by enabling the pressure in the cooking cavity to alternate between the second pressure and the third pressure after reaching the first pressure, compared with a manner in the related art that the rice grains rely on themselves to absorb moisture slowly, the water can be pressed into the rice grains actively by means of continuously changing pressure, such that the rice grains in the cooking cavity can fully absorb the moisture, the water absorption efficiency of the rice grains can be improved, the water content of the rice grains can be further ensured to further guarantee the quality of the cooked rice, and also the time required for cooking the rice can be further shortened to further improve the cooking efficiency of the rice cooker.

Accordingly, the control method according to embodiments of the present disclosure has advantages of the good cooking effect and the high cooking efficiency.

The control method according to embodiments of the present disclosure will be described below with reference to the drawings.

In some embodiments of the present disclosure, as illustrated in FIGS. 1 and 2, the cooking stage of the rice cooker at least includes the water absorption stage, the heating stage and the boiling stage. The rice cooker includes the pot, the cover and the pressure-changing device, the pot defines the cooking cavity therein, the cover is mounted to the pot and is movable between the closed position and the open position, and the pressure-changing device is disposed to the pot and/or the cover to control the pressure in the cooking cavity to change. The control method includes:

When the rice cooker enters the water absorption stage, controlling the pressure-changing device to change the pressure in the cooking cavity of the rice cooker from the normal pressure to the first pressure;

After the pressure in the cooking cavity is changed to the first pressure, controlling the pressure-changing device to enable the pressure in the cooking cavity to alternate between the second pressure and the third pressure.

In some embodiments of the present disclosure, as illustrated in FIG. 2, the second pressure and the third pressure are both positive pressures or are both negative pressures. In other words, the second pressure and the third pressure both may be greater than 1 standard atmospheric pressure, and may also be smaller than 1 standard atmospheric pressure. Thus, the pressure in the cooking cavity can be changed under the positive pressure or under the negative pressure all the time.

In some other embodiments of the present disclosure, one of the second pressure and the third pressure is the positive pressure, and the other of the second pressure and the third pressure is the negative pressure. In other words, one of the second pressure and the third pressure is greater than 1 standard atmospheric pressure, and the other one is smaller than 1 standard atmospheric pressure. Thus, the pressure in the cooking cavity can be changed between the positive pressure and the negative pressure.

In one embodiment, an absolute value of a difference between the second pressure and the third pressure is ΔP, and the ΔP≥1 KPa. Thus, a minimum pressure change magnitude in the cooking cavity can be defined such that a pressure change degree in the cooking cavity can be ensured, and the water absorption efficiency of the rice grains can be ensured.

Further, the control method further includes:

S3. when the pressure in the cooking cavity alternates between the second pressure and the third pressure for a predetermined water absorption time, controlling the rice cooker to enter the heating stage. Thus, it can be ensured that the subsequent cooking stage can be entered after the rice fully absorbs the water, such that a water absorption effect of the rice can be further ensured, and the quality of the rice can be ensured.

In one embodiment, the control method further includes: detecting the pressure in the cooking cavity in real time, and controlling the pressure-changing device depending on the pressure in the cooking cavity. Thus, it is convenient to detect whether the pressure reaches the second pressure and the third pressure, such that the control over the pressure change in the cooking cavity can be facilitated.

The rice cooker according to embodiments of the present disclosure will be described below. The rice cooker according to embodiments of the present disclosure performs cooking through the control method for the rice cooker according to the above embodiments of the present disclosure.

By performing cooking through the control method for the rice cooker according to the above embodiments of the present disclosure, the rice cooker according to embodiments of the present disclosure has advantages of the good cooking effect and the high cooking efficiency.

A rice cooker 1 according to embodiments of the present disclosure will be described below. The rice cooker 1 according to embodiments of the present disclosure includes the pot 10, the cover 30 and the pressure-changing device.

The pot defines the cooking cavity 21 therein. The cover 30 is mounted to the pot 10 and is movable between the closed position and the open position. The pressure-changing device is disposed to the pot 10 and/or the cover 30 to change the pressure in the cooking cavity 21. The pressure-changing device is configured to change the pressure in the cooking cavity 21 of the rice cooker 1 from the normal pressure to the first pressure when the rice cooker 1 enters the water absorption stage of the cooking stage, and enable the pressure in the cooking cavity 21 to alternate between the second pressure and the third pressure after the pressure in the cooking cavity 21 is changed to the first pressure.

In one embodiment, the pot 10 is provided with an inner pot 20 therein, and the inner pot 20 defines the cooking cavity 21 therein.

In the rice cooker 1 according to embodiments of the present disclosure, by changing the pressure in the cooking cavity 21 from the normal pressure to the first pressure, the pressure in the cooking cavity 21 can reach a pressure value which is most suitable for the water absorption of the rice grains, and the environment in cooking cavity 21 reaches an environment which is most suitable for the water absorption of the rice grains, such that the water absorption efficiency of the rice grains can be improved, the water content of the rice grains can be ensured to guarantee the quality of the cooked rice, and also the time required for cooking the rice can be shortened to improve the cooking efficiency of the rice cooker 1.

In addition, by enabling the pressure in the cooking cavity 21 to alternate between the second pressure and the third pressure after reaching the first pressure, compared with a manner in the related art that the rice grains relies on themselves to absorb moisture slowly, the water can be pressed into the rice grains actively by means of continuously changing pressure, such that the rice grains in the cooking cavity 21 can fully absorb the moisture, the water absorption efficiency of the rice grains can be improved, the water content of the rice grains can be further ensured to further guarantee the quality of the cooked rice, and also the time required for cooking the rice can be further shortened to further improve the cooking efficiency of the rice cooker 1.

The rice cooker 1 according to embodiments of the present disclosure has advantages of the good cooking effect and the high cooking efficiency.

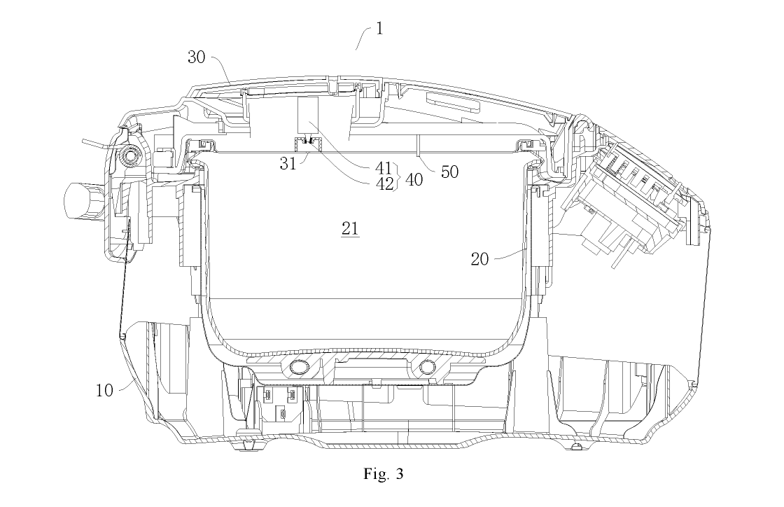

In one embodiment, as illustrated in FIG. 3, the pressure-changing device includes a negative pressure device 40 and a pressurizing device. The negative pressure device 40 is disposed in the pot 10 or the cover 30 to achieve the negative pressure in the cooking cavity 21. The pressurizing device is disposed in the pot 10 or the cover 30 to pressurize the cooking cavity 21. Thus, the negative pressure device 40 and the pressurizing device can be used to depressurize and pressurize the cooking cavity 21 respectively, thereby facilitating the pressure change in the cooking cavity 21.

Advantageously, as illustrated in FIG. 3, the rice cooker 1 further includes a pressure detection device 50, and the pressure detection device 50 is disposed in the pot 10 or the cover 30 to detect the pressure in the cooking cavity 21. In one embodiment, the pressure detection device 50 is disposed in the pot 10 and detects the pressure in the cooking cavity 21 in real time, and controls the pressure-changing device depending on the pressure in the cooking cavity 21. Thus, the pressure detection device 50 can be used to detect a pressure state in the cooking cavity 21, thereby facilitating the control over working states of the negative pressure device 40 and the pressurizing device.

For example, when a detection value of the pressure detection device 50 rises to Pmax, the negative pressure device 40 is controlled to perform depressurization, and when the detection value of the pressure detection device 50 decreases to Pmin, the pressurizing device is controlled to perform pressurization.

In one embodiment, as illustrated in FIG. 3, the negative pressure device 40 includes an airflow path 42 and a vacuum pump 41. A first end of the airflow path 42 is in communication with the cooking cavity 21, and a second end thereof is in communication with an air storage device or the outside. The vacuum pump 41 is in communication with the airflow path to generate the negative pressure in the cooking cavity 21. Thus, the vacuum pump 41 can be used to generate the negative pressure in the cooking cavity 21.

Further, as illustrated in FIG. 3, the negative pressure device 40 is disposed in the cover 30, an air extraction opening 31 is defined in a surface of the cover 30 fitted with the cooking cavity 21, and the air extraction opening 31 is in communication with the airflow path 42. Thus, the vacuum pump 41 can extract the air in the cooking cavity 21 through the air extraction opening 31 and the airflow path 42, so as to generate the negative pressure in the cooking cavity 21.

In one embodiment, the negative pressure device 40 further includes an electromagnetic valve, and the electromagnetic valve is connected between the air extraction opening 31 and the vacuum pump 41. Thus, the electromagnetic valve can be used to control opening and closure of the vacuum pump 41 and the air extraction opening 31, so as to control a control state of the vacuum pump 41 regarding the pressure in the cooking cavity 21.

The rice cooker 1 according to a an example of the present disclosure is illustrated in FIG. 3. As illustrated in FIG. 3, the pressurizing device is disposed in the cover 30, and is in communication with the cooking cavity 21 through an air intake port, and the air intake port is defined in the surface of the cover 30 fitted with the cooking cavity 21. Thus, control of the pressurizing device over the air intake port can be used to achieve control over the pressure in the cooking cavity 21.

In one embodiment, the pressurizing device includes a blocking member. The blocking member is disposed at the air intake port and is movable between a blocked position and an unblocked position, the blocking member closes the air intake port when in the blocked position, and the cooking cavity is in communication with the outside when the blocking member is in the unblocked position. Thus, the pressurizing device can be used to open or close the air intake port to achieve the control over the pressure in the cooking cavity 21.

In one embodiment, the pressurizing device further includes a drive assembly, and the drive assembly drives the blocking member to move between the blocked position and the unblocked position. Thus, the drive assembly can be used to drive the blocking member, so as to achieve the opening and closure of the air intake port by the blocking member.

Further, the drive assembly includes an electromagnet and a push rod, and the electromagnet drives the push rod to urge the blocking member to move. Thus, the electromagnet can be used to drive the push rod to urge the blocking member, so as to control the opening and closing state of the blocking member.

An operation process of the rice cooker 1 according to embodiments of the present disclosure will be described in the following with reference to FIGS. 1 to 3.

A user adds the rice and the water in the inner pot 20, and operates the rice cooker 1 to work. The pressure-changing device changes the pressure in the cooking cavity 21 from the normal pressure to the first pressure when the rice cooker 1 enters the water absorption stage; after the pressure detection device 50 detects that the pressure in the cooking cavity 21 is changed to the first pressure, the pressure-changing device changes the pressure again such that the pressure in the cooking cavity 21 is changed to the second pressure; after the pressure detection device 50 detects that the pressure in the cooking cavity 21 is changed to the second pressure, the pressure-changing device changes the pressure again such that the pressure in the cooking cavity 21 can be changed to the third pressure. The pressure change is repeated in this way, such that the pressure in the cooking cavity 21 can alternate between the second pressure and the third pressure. When the pressure in the cooking cavity 21 alternates between the second pressure and the third pressure for a predetermined water absorption time, the rice cooker is controlled to enter the heating stage.

Thus, the pressure in the cooking cavity 21 is changed repeatedly to actively press the water into the rice grains, such that the water absorption speed and the water content can be improved, the quality of the final rice can be improved, and the cooking time can be shortened.

Other constitutions and operations of the rice cooker 1 according to embodiments of the present disclosure are possible, which will not be described in detail herein.

Reference throughout this specification to “an embodiment,” “some embodiments,” “an illustrative embodiment,” “an example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

What is claimed is:

1. A control method for a rice cooker, a cooking stage of the rice cooker at least comprising:
a water absorption stage, a heating stage and a boiling stage, wherein the rice cooker comprises a pot, a cover and a pressure-changing device, the pot defines a cooking cavity therein, the cover is mounted to the pot and is movable between a closed position and an open position, the pressure-changing device is disposed to the pot and/or the cover to control a pressure in the cooking cavity to change, and the control method comprises:
controlling the pressure-changing device to change the pressure in the cooking cavity of the rice cooker from a normal pressure to a first pressure, when the rice cooker enters the water absorption stage;
controlling the pressure-changing device to enable the pressure in the cooking cavity to alternate between a second pressure and a third pressure, after the pressure in the cooking cavity is changed to the first pressure.

2. The control method according to claim 1, wherein the second pressure and the third pressure are both positive pressures or are both negative pressures; or one of the second pressure and the third pressure is the positive pressure, and the other of the second pressure and the third pressure is the negative pressure,
an absolute value of a difference between the second pressure and the third pressure is ΔP, and the ΔP≥1 KPa.

3. The control method according to claim 1, wherein one of the second pressure and the third pressure is equal to the first pressure, and the other of the second pressure and the third pressure is greater than or smaller than the first pressure.

4. The control method according to claim 1, wherein one of the second pressure and the third pressure is greater than the first pressure, and the other of the second pressure and the third pressure is smaller than the first pressure.

5. The control method according to claim 1, wherein the second pressure and the third pressure are both greater than or are both smaller than the first pressure.

6. The control method according to claim 1, further comprising:
S3: controlling the rice cooker to enter the heating stage, when the pressure in the cooking cavity alternates between the second pressure and the third pressure for a predetermined water absorption time.

7. The control method according claim 1, further comprising:
detecting the pressure in the cooking cavity in real time, and controlling the pressure-changing device depending on the pressure in the cooking cavity.

8. A rice cooker comprising:
a controller configured to implement:
a cooking stage of the rice cooker at least comprising a water absorption stage, a heating stage and a boiling stage, wherein the rice cooker comprises a pot, a cover and a pressure-changing device, the pot defines a cooking cavity therein, the cover is mounted to the pot and is movable between a closed position and an open position, the pressure-changing device is disposed to the pot and/or the cover to control a pressure in the cooking cavity to change, and the control method comprises:
controlling the pressure-changing device to change the pressure in the cooking cavity of the rice cooker from a normal pressure to a first pressure, when the rice cooker enters the water absorption stage;
controlling the pressure-changing device to enable the pressure in the cooking cavity to alternate between a second pressure and a third pressure, after the pressure in the cooking cavity is changed to the first pressure.

9. A rice cooker, comprising:
a pot defining a cooking cavity therein;
a cover mounted to the pot and movable between a closed position and an open position; and
a pressure-changing device disposed to the pot and/or the cover to change a pressure in the cooking cavity, wherein the pressure-changing device is configured to change the pressure in the cooking cavity of the rice cooker from a normal pressure to a first pressure when the rice cooker enters a water absorption stage of a cooking stage, and is configured to enable the pressure in the cooking cavity to alternate between a second pressure and a third pressure after the pressure in the cooking cavity is changed to the first pressure.

10. The rice cooker according to claim 9, wherein the pressure-changing device comprises:
a negative pressure device disposed in the pot or the cover to achieve a negative pressure in the cooking cavity; and
a pressurizing device disposed in the pot or the cover to pressurize the cooking cavity.

11. The rice cooker according to claim 9, further comprising a pressure detection device, wherein the pressure detection device is disposed in the pot and detects the pressure in the cooking cavity in real time, and controls the pressure-changing device depending on the pressure in the cooking cavity.

12. The rice cooker according to claim 10, wherein the negative pressure device comprises:
an airflow path, having a first end in communication with the cooking cavity and a second end in communication with an air storage device or the outside; and
a vacuum pump in communication with the airflow path to generate the negative pressure in the cooking cavity.

13. The rice cooker according to claim 12, wherein the negative pressure device is disposed in the cover, an air extraction opening is defined in a surface of the cover fitted with the cooking cavity, and the air extraction opening is in communication with the airflow path.

14. The rice cooker according to claim 13, wherein the negative pressure device further comprises an electromagnetic valve connected between the air extraction opening and the vacuum pump.

15. The rice cooker according to claim 10, wherein the pressurizing device is disposed in the cover, and is in communication with the cooking cavity through an air intake port, the air intake port being defined in a surface of the cover fitted with the cooking cavity.

16. The rice cooker according to claim 15, wherein the pressurizing device comprises:
a blocking member disposed at the air intake port and movable between a blocked position and an unblocked position, wherein the blocking member closes the air intake port when in the blocked position, and the cooking cavity is in communication with the outside when the blocking member is in the unblocked position.

17. The rice cooker according to claim 16, wherein the pressurizing device further comprises a drive assembly, and the drive assembly drives the blocking member to move between the blocked position and the unblocked position.

18. The rice cooker according to claim 17, wherein the drive assembly comprises an electromagnet and a push rod, and the electromagnet drives the push rod to urge the blocking member to move.
